(19) United States
(12) Patent Application Publication
(10) Pub. No.: US 2024/0422438 A1
(43) Pub. Date: Dec. 19, 2024

(54) IMAGING APPARATUS

(71) Applicant: Panasonic Intellectual Property Management Co., Ltd., Osaka (JP)

(72) Inventor: Hiroyuki KUROKI, Osaka (JP)

(73) Assignee: Panasonic Intellectual Property Management Co., Ltd., Osaka (JP)

(21) Appl. No.: 18/737,195

(22) Filed: Jun. 7, 2024

(30) Foreign Application Priority Data
Jun. 14, 2023 (JP) 2023-097647

(51) Int. Cl. H04N 23/68

(52) U.S. Cl. CPC H04N 23/687

(57) ABSTRACT

An imaging apparatus includes: a fixing portion fixed inside a casing; a movable portion that includes an imaging element and moves in a direction orthogonal to an optical axis with respect to the fixing portion; and a connection member including a first connection portion connected to the fixing portion and a second connection portion connected to the movable portion, in which the connection member includes a plurality of bent portions gently curved between the first connection portion and the second connection portion, in which the plurality of bent portions include a first bent portion curved about a first virtual axis and a second bent portion curved about a second virtual axis, and in which the first virtual axis and the second virtual axis each extend in a direction orthogonal to the optical axis.

### TECHNICAL FIELD

The present disclosure relates to an imaging apparatus that images a subject.

### BACKGROUND ART

Patent Document 1 discloses an image blur correction device that corrects image blur by moving a movable body having an imaging element in a direction orthogonal to an optical axis direction with respect to a fixed body, and an imaging apparatus including the image blur correction device.

The imaging apparatus of Patent Document 1 includes a bendable heat transfer sheet (graphite sheet) that transfers heat generated in the movable body to the fixed body, and a thickness direction of the heat transfer sheet is a direction orthogonal to the optical axis direction.

### PATENT DOCUMENT

Patent Document 1: WO 2020/202811 A1

### SUMMARY

### Problems to be Solved by the Invention

In the imaging apparatus of Patent Document 1, the deformation resistance of the heat transfer sheet increases as the movement amount of the movable body increases. It is required to stably reduce the deformation resistance of the heat transfer sheet regardless of the moving amount and the moving direction of the movable body.

The present disclosure provides an imaging apparatus capable of stably reducing resistance when a movable portion moves.

### Solutions to the Problems

An imaging apparatus according to one aspect of the present disclosure includes: a fixing portion fixed inside a casing; a movable portion that includes an imaging element and moves in a direction orthogonal to an optical axis with respect to the fixing portion; and a connection member including a first connection portion connected to the fixing portion and a second connection portion connected to the movable portion, in which the connection member includes a plurality of bent portions gently curved between the first connection portion and the second connection portion, in which the plurality of bent portions include a first bent portion curved about a first virtual axis and a second bent portion curved about a second virtual axis, and in which the first virtual axis and the second virtual axis each extend in a direction orthogonal to the optical axis.

Furthermore, an imaging apparatus according to another aspect of the present disclosure includes: a fixing portion fixed inside a casing; a movable portion that includes an imaging element and moves in a direction orthogonal to an optical axis with respect to the fixing portion; and a connection member including a first connection portion connected to the fixing portion and a second connection portion connected to the movable portion, in which the connection member includes a first bent portion gently curved between the first connection portion and the second connection portion, and in which the first bent portion is spirally curved.

### Effects of the Invention

According to the imaging apparatus of the present disclosure, it is possible to stably reduce resistance when the movable portion moves.

### BRIEF DESCRIPTION OF DRAWINGS

FIG. 1 is a schematic perspective view of an imaging apparatus according to a first embodiment of the present disclosure;

FIG. 2 is a schematic perspective view of the imaging apparatus according to the first embodiment;

FIG. 3 is a perspective view illustrating a peripheral structure of a camera shake correction mechanism according to the first embodiment;

FIG. 4 is a perspective view illustrating a peripheral structure of the camera shake correction mechanism according to the first embodiment;

FIG. 5 is a side view illustrating a peripheral structure of the camera shake correction mechanism according to the first embodiment;

FIG. 6 is an exploded perspective view of a fixing portion, a movable portion, and heat transfer sheets according to the first embodiment;

FIG. 7 is an exploded perspective view of the fixing portion, the movable portion, and the heat transfer sheets according to the first embodiment;

FIG. 8 is a schematic plan view illustrating a state in which the heat transfer sheets according to the first embodiment are attached to a movable frame;

FIG. 9 is a perspective view of the heat transfer sheet according to the first embodiment;

FIG. 10 is a perspective view of the heat transfer sheet according to the first embodiment;

FIG. 11 is a plan view of the heat transfer sheet according to the first embodiment;

FIG. 12 is a schematic view illustrating a deformation state of the heat transfer sheet when a connection portion of the heat transfer sheet according to the first embodiment moves in a left direction of the drawing;

FIG. 13 is a schematic view illustrating a deformation state of the heat transfer sheet when the connection portion of the heat transfer sheet according to the first embodiment moves in a right direction of the drawing;

FIG. 14 is a schematic view illustrating a deformation state of the heat transfer sheet when the connection portion of the heat transfer sheet according to the first embodiment moves in an upward direction of the drawing;

FIG. 15 is a schematic view illustrating a deformation state of the heat transfer sheet when the connection portion of the heat transfer sheet according to the first embodiment moves in a downward direction of the drawing;

FIG. 16 is a schematic view illustrating a deformation state of the heat transfer sheet when the connection portion of the heat transfer sheet according to the first embodiment moves obliquely upward;

FIG. 17 is a schematic view illustrating a deformation state of the heat transfer sheet when the connection portion of the heat transfer sheet according to the first embodiment moves obliquely downward;

FIG. 18 is a perspective view illustrating a peripheral structure of a camera shake correction mechanism according to a second embodiment;

FIG. 19 is a perspective view in a state where a fixing portion is omitted from the structure illustrated in FIG. 18; and

FIG. 20 is a perspective view of heat transfer sheets according to the second embodiment.

### DETAILED DESCRIPTION

According to a first aspect of the present disclosure, there is provided an imaging apparatus including: a fixing portion fixed inside a casing; a movable portion that includes an imaging element and moves in a direction orthogonal to an optical axis with respect to the fixing portion; and a connection member including a first connection portion connected to the fixing portion and a second connection portion connected to the movable portion, in which the connection member includes a plurality of bent portions gently curved between the first connection portion and the second connection portion, in which the plurality of bent portions include a first bent portion curved about a first virtual axis and a second bent portion curved about a second virtual axis, and in which the first virtual axis and the second virtual axis each extend in a direction orthogonal to the optical axis.

According to a second aspect of the present disclosure, the imaging apparatus according to the first aspect is provided, in which the first virtual axis and the second virtual axis are parallel to each other.

According to a third aspect of the present disclosure, the imaging apparatus according to the first aspect or the second aspect is provided, in which the first connection portion and the second connection portion are at positions shifted along a direction orthogonal to the optical axis.

According to a fourth aspect of the present disclosure, the imaging apparatus according to any one of the first to third aspects is provided, in which the connection member includes an extending portion extending between the first bent portion and the second bent portion, and a reinforcing plate attached to the extending portion.

According to a fifth aspect of the present disclosure, the imaging apparatus according to any one of the first to fourth aspects is provided, in which the connection member extends in a first direction from the second connection portion toward the first bent portion, extends in a second direction opposite to the first direction from the first bent portion toward the second bent portion, and extends in the first direction from the second bent portion toward the first connection portion.

According to a sixth aspect of the present disclosure, the imaging apparatus according to any one of the first to fifth aspects is provided, in which the connection member is a heat transfer sheet that transfers heat of the movable portion to the fixing portion.

According to a seventh aspect of the present disclosure, the imaging apparatus according to any one of the first to sixth aspects is provided, in which the connection member includes a third connection portion connected to the fixing portion at a position different from the first connection portion, and a plurality of bent portions gently curved between the second connection portion and the third connection portion, in which the plurality of bent portions include a third bent portion curved about a third virtual axis and a fourth bent portion curved about a fourth virtual axis, and in which each of the third virtual axis and the fourth virtual axis extends in a direction orthogonal to the optical axis.

According to an eighth aspect of the present disclosure, the imaging apparatus according to the seventh aspect is provided, in which the connection member extends in a first direction from the second connection portion toward the first bent portion, and extends in a second direction from the second connection portion toward the third bent portion.

According to a ninth aspect of the present disclosure, the imaging apparatus according to the eighth aspect is provided, in which the first direction and the second direction are opposite to each other.

According to a tenth aspect of the present disclosure, the imaging apparatus according to the eighth or ninth aspect is provided, in which the first bent portion is curved from the first direction to the second direction toward the second bent portion, and the second bent portion is curved from the second direction to the first direction, and the third bent portion is curved from the second direction to the first direction toward the fourth bent portion, and the fourth bent portion is curved from the first direction to the second direction.

According to an eleventh aspect of the present disclosure, there is provided an imaging apparatus including: a fixing portion fixed inside a casing; a movable portion that includes an imaging element and moves in a direction orthogonal to an optical axis with respect to the fixing portion; and a connection member including a first connection portion connected to the fixing portion and a second connection portion connected to the movable portion, in which the connection member includes a first bent portion gently curved between the first connection portion and the second connection portion, and in which the first bent portion is spirally curved.

According to a twelfth aspect of the present disclosure, the imaging apparatus according to the eleventh aspect is provided, in which the first bent portion is spirally curved about a first virtual axis extending in a direction orthogonal to the optical axis.

According to a thirteenth aspect of the present disclosure, the imaging apparatus according to the eleventh or twelfth aspect is provided, in which the connection member includes a third connection portion connected to the fixing portion at a position different from the first connection portion, and a second bent portion gently curved between the second connection portion and the third connection portion, and the second bent portion is spirally curved.

According to a fourteenth aspect of the present disclosure, the imaging apparatus according to the thirteenth aspect is provided, in which the connection member have a bifurcated shape extending from the second connection portion toward the first bent portion and extending from the second connection portion toward the second bent portion.

Preferred embodiments are described in detail below with reference to the drawings as appropriate. However, unnecessarily detailed description may be omitted. For example, a detailed description of already well-known matters and an overlapping description for substantially the same configuration may be omitted. This is to avoid the following description from becoming unnecessary redundant and to facilitate understanding by those skilled in the art. In addition, the inventor(s) provides the accompanying drawings and the following description to enable those skilled in the art to sufficiently understand the present disclosure, which does not intend to limit the claimed subject matter.

### First Embodiment

In a first embodiment, a digital camera as an example of an imaging apparatus according to the present disclosure will be described.

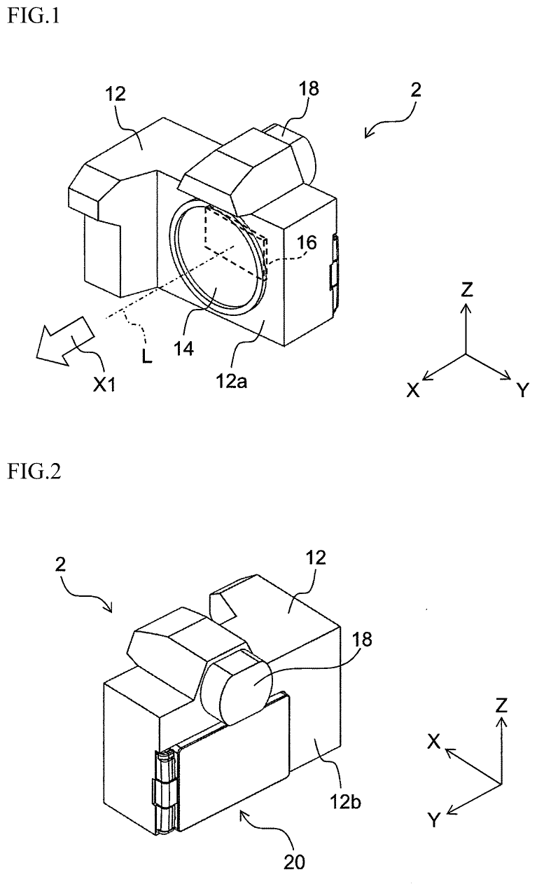

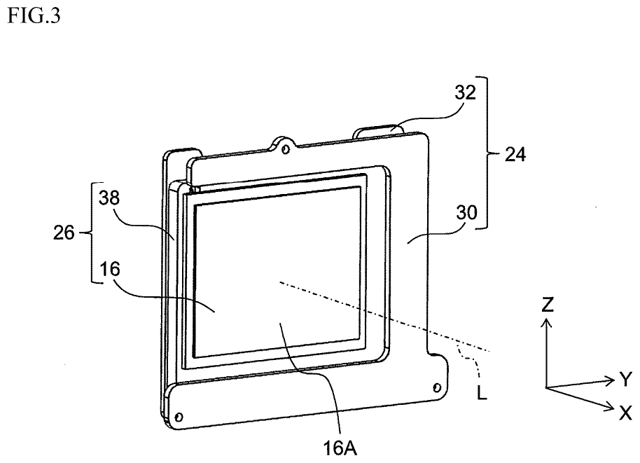

A configuration of an imaging apparatus 2 according to the first embodiment will be described with reference to FIGS. 1 and 2. Hereinafter, the front-back direction as viewed from a user using the imaging apparatus 2 is defined as the X-axis direction, the left-right direction is defined as the Y-axis direction, and the up-down direction is defined as the Z-axis direction. Terms indicating directions such as “upper”, “lower”, “front”, “rear”, “left”, and “right” are used, but the usage state and the like of the imaging apparatus of the present disclosure are not limited.

FIGS. 1 and 2 are perspective views schematically illustrating the imaging apparatus 2 according to the first embodiment. The imaging apparatus 2 illustrated in FIGS. 1 and 2 includes a casing 12. A lens 14 is provided on a front surface 12a of the casing 12. The lens 14 is oriented in an imaging direction X1 on the front side along an optical axis L extending in the X-axis direction. An imaging element 16 on which an image of a subject transmitted through a lens 14 is formed is provided inside the casing 12.

The imaging element 16 converts the image of the subject formed through the lens 14 into image data. The image data is displayed on an electronic viewfinder 18 and on a monitor unit 20 (FIG. 2).

The monitor unit 20 is provided on a rear surface 12b of the casing 12 and below the electronic viewfinder 18. The monitor unit 20 is configured to be foldable by a hinge mechanism, and FIGS. 1 and 2 illustrate a state in which the monitor unit 20 is folded inward.

The imaging apparatus 2 having the above configuration incorporates a camera shake correction mechanism (image blur correction device) for correcting camera shake. A peripheral structure of the camera shake correction mechanism according to the first embodiment will be described with reference to FIGS. 3 and subsequent drawings.

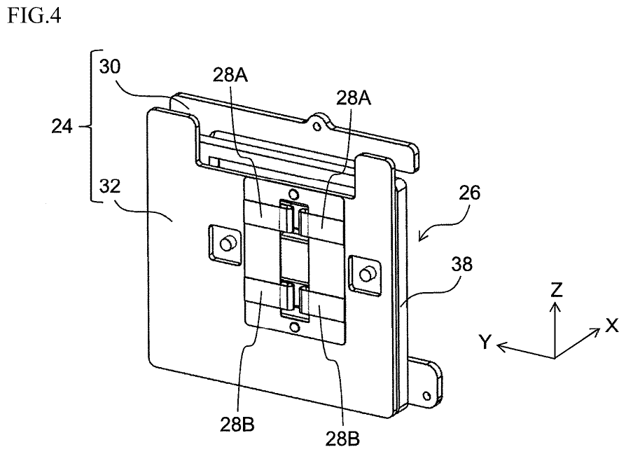

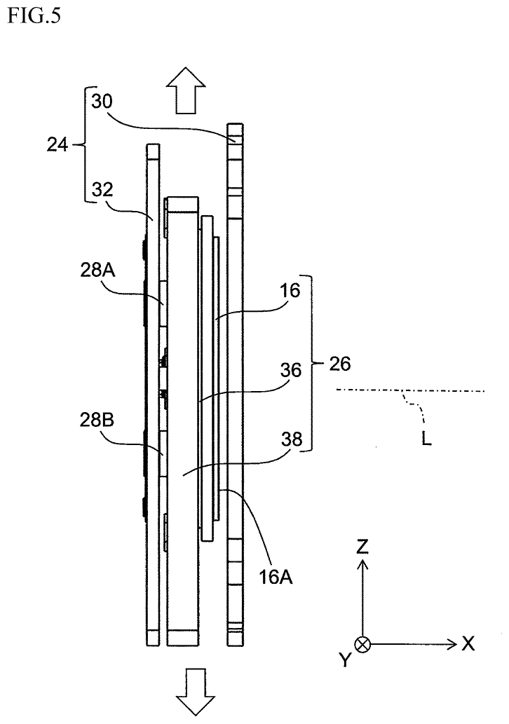

FIGS. 3 and 4 are perspective views illustrating a peripheral structure of the camera shake correction mechanism according to the first embodiment, and FIG. 5 is a side view of the peripheral structure according to the first embodiment.

As illustrated in FIGS. 3 to 5, the imaging apparatus 2 of the first embodiment includes a fixing portion 24, a movable portion 26, and heat transfer sheets 28A and 28B (FIGS. 4 and 5).

The fixing portion 24 is a portion fixed inside the casing 12 illustrated in FIGS. 1 and 2. The fixing portion 24 is indirectly fixed to the casing 12 via another member (not illustrated). The movable portion 26 is a portion that is movable without being fixed to the casing 12, and moves in the YZ plane to realize the camera shake correction function. The movable portion 26 is supported to be integrally movable in the YZ plane by a steel ball which is a member having high rigidity while being attracted by magnetic force.

Each of the heat transfer sheets 28A and 28B is a connection member connected between the fixing portion 24 and the movable portion 26, and has a function of transmitting the heat of the movable portion 26 to the fixing portion 24. Each of the heat transfer sheets 28A and 28B is made of a member having flexibility (for example, a flexible sheet) so as to follow the movement of the movable portion 26.

The fixing portion 24 illustrated in FIGS. 3 to 5 includes two fixing frames 30 and 32. The fixing frame 30 is a frame arranged on the front side (+X direction) with respect to the movable portion 26, and the fixing frame 32 is a frame arranged on the rear side (−X direction) with respect to the movable portion 26.

The movable portion 26 illustrated in FIGS. 3 to 5 includes the imaging element 16, a sensor substrate 36 (FIG. 5), and a movable frame 38. As illustrated in FIG. 5, the imaging element 16, the sensor substrate 36, and the movable frame 38 are arranged in this order from the front side of the imaging apparatus 2.

The imaging element 16 is an element that captures a subject image incident via the lens 14 and generates image data, and is, for example, an image sensor such as a CMOS image sensor. The imaging element 16 has a plate shape and has a main surface 16A. The optical axis L extends along the X-axis direction so as to be orthogonal to the main surface 16A. The imaging element 16 is mounted on the sensor substrate 36.

The sensor substrate 36 is a substrate for attaching and supporting the imaging element 16, and has a plate shape. The sensor substrate 36 is electrically connected to a main substrate (not illustrated), and is attached to and supported by the movable frame 38. The movable frame 38 is a frame that integrally supports the sensor substrate 36 and the imaging element 16.

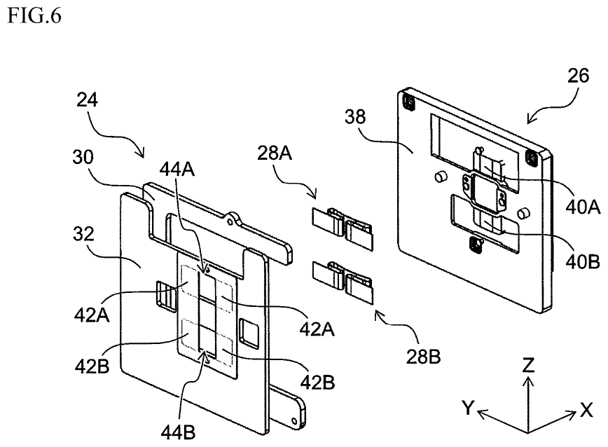

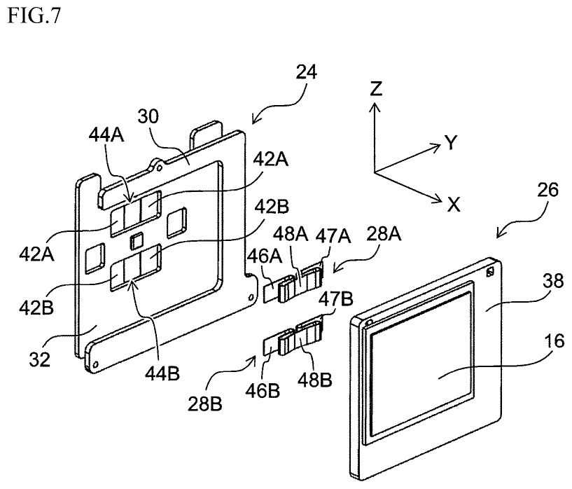

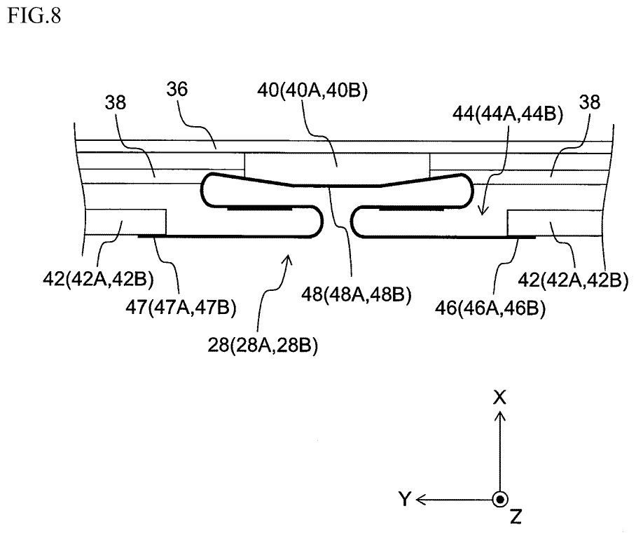

FIGS. 6 and 7 are perspective views illustrating a state in which the fixing portion 24, the movable portion 26, and the heat transfer sheets 28A and 28B are disassembled. FIG. 8 is a plan view schematically illustrating a state in which the heat transfer sheets 28A and 28B are attached to the movable frame 38 of the movable portion 26.

As illustrated in FIGS. 6 and 7, in the first embodiment, two heat transfer sheets 28A and 28B are provided. The number of the heat transfer sheets 28A and 28B is not limited to two, and may be any number of one or more. Since the portions to which the heat transfer sheets 28A and 28B and the heat transfer sheets 28A and 28B are attached have the same structure, hereinafter, the heat transfer sheets 28A and 28B are collectively referred to as “heat transfer sheets 28”, and the other members may be denoted in the same manner.

As illustrated in FIG. 6, the movable frame 38 of the movable portion 26 includes attachment portions 40A and 40B for attaching the heat transfer sheets 28A and 28B. The attachment portions 40A and 40B have surfaces facing the rear side (−X direction) of the imaging apparatus 2.

The fixing frame 32 of the fixing portion 24 has attachment portions 42A and 42B for attaching the heat transfer sheets 28A and 28B. The attachment portions 42A and 42B have surfaces facing the rear side (−X direction) of the imaging apparatus 2.

The fixing frame 32 is provided with two through holes 44A and 44B. A pair of attachment portions 42A is provided so as to sandwich the through hole 44A in the left-right direction, and a pair of attachment portions 42B is provided so as to sandwich the through hole 44B in the left-right direction. The through holes 44A and 44B are holes for allowing the heat transfer sheets 28A and 28B to pass to the rear side of the fixing frame 32, respectively.

As illustrated in FIG. 7, the heat transfer sheet 28A includes connection portions 46A and 47A for connecting to the attachment portion 42A of the fixing frame 32, and a connection portion 48A for connecting to the attachment portion 40A of the movable frame 38.

As illustrated in FIG. 8, each of the connection portions 46A and 47A is attached to the attachment portion 42A by adhesion via an adhesive member such as a double-sided tape. The connection portion 48A is attached to the attachment portion 40A by adhesion via an adhesive member such as a double-sided tape.

Similarly, the heat transfer sheet 28B includes connection portions 46B and 47B for connecting to the attachment portion 42B of the fixing portion 24 and a connection portion 48B for connecting to the attachment portion 40B of the movable frame 38.

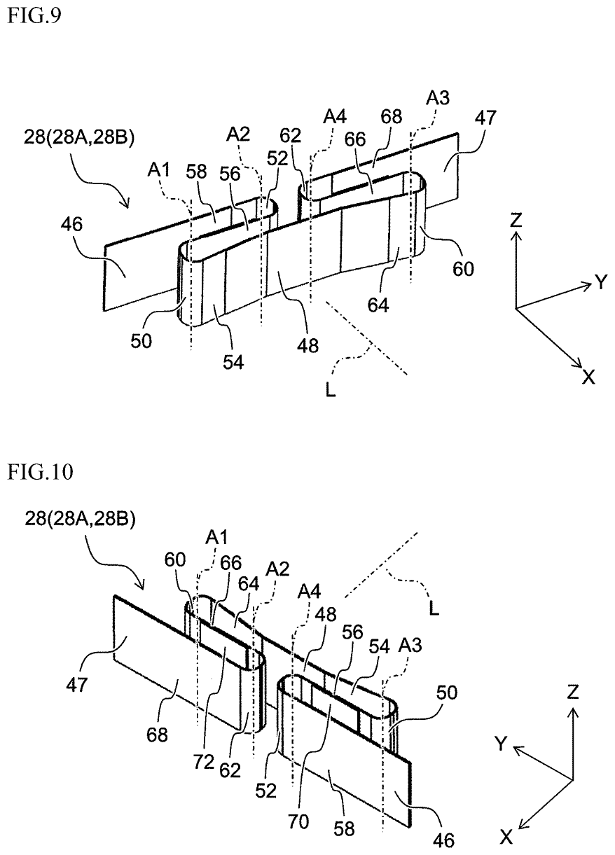

Next, a detailed configuration of the heat transfer sheet 28 (28A, 28B) will be described with reference to FIGS. 9 to 11.

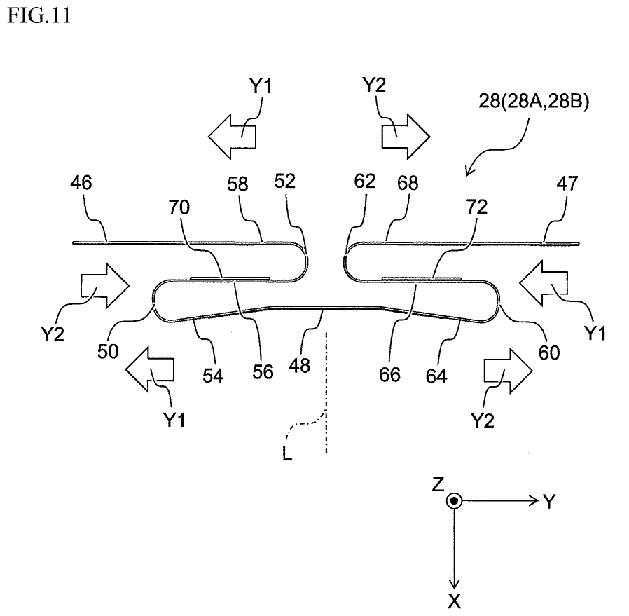

FIGS. 9 and 10 are perspective views of the heat transfer sheet 28, and FIG. 11 is a plan view of the heat transfer sheet 28.

The heat transfer sheet 28 illustrated in FIGS. 9 to 11 is a plate-like integral member having a uniform thickness, and for example, a graphite sheet having high thermal conductivity is used. The heat transfer sheet 28 has a plurality of bent portions 50, 52, 60, and 62 at positions different from the connection portions 46, 47, and 48.

The bent portions 50, 52, 60, and 62 are gently (smoothly) curved around virtual axes A1, A2, A3, and A4, respectively. The bent portion 50 is curved around the virtual axis A1, the bent portion 52 is curved around the virtual axis A2, the bent portion 60 is curved around the virtual axis A3, and the bent portion 62 is curved around the virtual axis A4.

In the first embodiment, the virtual axes A1, A2, A3, and A4 extend in parallel directions. Each of the virtual axes A1, A2, A3, and A4 extends in the up-down direction (Z-axis direction), that is, in the direction orthogonal to the optical axis L in a connection state in which the heat transfer sheet 28 is connected between the fixing portion 24 and the movable portion 26.

The heat transfer sheet 28 further includes extending portions 54, 56, and 58 and extending portions 64, 66, and 68.

The extending portion 54 is a portion extending substantially linearly between the connection portion 48 and the bent portion 50, the extending portion 56 is a portion extending substantially linearly between the bent portion 50 and the bent portion 52, and the extending portion 58 is a portion extending substantially linearly between the bent portion 52 and the connection portion 46.

Similarly, the extending portion 64 is a portion extending substantially linearly between the connection portion 48 and the bent portion 60, the extending portion 66 is a portion extending substantially linearly between the bent portion 60 and the bent portion 62, and the extending portion 68 is a portion extending substantially linearly between the bent portion 62 and the connection portion 47.

The heat transfer sheet 28 of the first embodiment has a bifurcated shape starting from the connection portion 48 at the center. Specifically, the extending portion 54, the bent portion 50, the extending portion 56, the bent portion 52, the extending portion 58, and the connection portion 46 continuously extend in this order on one side with respect to the connection portion 48. The extending portion 64, the bent portion 60, the extending portion 66, the bent portion 62, the extending portion 68, and the connection portion 47 continuously extend in this order on the other side with respect to the connection portion 48.

By forming the heat transfer sheet 28 into a bifurcated shape, the heat transfer sheet 28 can be connected to the fixing portion 24 in a well-balanced manner, and two heat transfer paths can be formed, so that heat dissipation performance can be improved. By integrally forming the heat transfer sheet 28 while being bifurcated, it is possible to reduce the work of attaching the heat transfer sheet 28 to the movable portion 26 as compared with the case of using two heat transfer sheets, and it is possible to save a place where the heat transfer sheet is attached.

As illustrated in FIG. 11, the extending portion 54 extends in a first direction Y1 toward one side with respect to the connection portion 48, and the bent portion 50 connected to the extending portion 54 is curved by approximately 180 degrees so as to be inverted from the first direction Y1 toward a second direction Y2. The extending portion 56 connected to the bent portion 50 extends in the second direction Y2, and the bent portion 52 is curved by approximately 180 degrees so as to be inverted from the second direction Y2 toward the first direction Y1. The heat transfer sheet 28 has a shape curved in an S shape in plan view on one side with respect to the connection portion 48.

Similarly, the extending portion 64 extends in the second direction Y2 toward the other side with respect to the connection portion 48, and the bent portion 60 connected to the extending portion 64 is curved by approximately 180 degrees so as to be inverted from the second direction Y2 toward the first direction Y1. The extending portion 66 connected to the bent portion 60 extends in the first direction Y1, and the bent portion 62 is curved by approximately 180 degrees so as to be inverted from the first direction Y1 toward the second direction Y2. The heat transfer sheet 28 has a shape curved in an S shape in plan view on the other side with respect to the connection portion 48.

As illustrated in FIG. 11, the connection portions 46 and 47 are provided at positions shifted in the left-right direction with respect to the connection portion 48. Since the heat transfer sheet 28 has the S-shape, it is possible to easily extend and connect the heat transfer sheet 28 to the connection portions 46 and 47 at positions separated in the left-right direction while providing the plurality of bent portions in the heat transfer sheet 28.

In the example shown in FIG. 11, the connection portion 48 extends obliquely toward the front side (+X direction) toward the extending portions 54 and 64, and the extending portions 54 and 64 also extend obliquely in the same direction.

The heat transfer sheet 28 further has two reinforcing plates 70 and 72. Each of the reinforcing plates 70 and 72 is a plate-shaped member made of a material (for example, a PET sheet) having higher rigidity than a plate-shaped main body portion (for example, a graphite sheet) of the heat transfer sheet 28. Deformation of the heat transfer sheet 28 is suppressed at positions where the reinforcing plates 70 and 72 are provided. The reinforcing plates 70 and 72 are provided to limit and specify deformation portions of the heat transfer sheet 28.

In the example illustrated in FIGS. 10 and 11, the reinforcing plate 70 is attached to the extending portion 56, and the reinforcing plate 72 is attached to the extending portion 66. The extending portions 56 and 66 to which the reinforcing plates 70 and 72 are attached are less likely to be deformed, and the bent portions 50, 52, 60, and 62 assumed to be deformed are likely to be deformed.

Note that a preferable range regarding the length that can be deformed (deformation length) from the connection portion 48 to the connection portions 46 and 47 in the heat transfer sheet 28 changes according to various factors such as the width (length in the Z-axis direction) of the heat transfer sheet 28. When the deformation length of the heat transfer sheet 28 is excessively short, the deformation resistance tends to increase, and when the deformation length is excessively long, the heat dissipation tends to decrease. Therefore, a preferable range of the deformation length may be set in consideration of the deformation resistance and the heat dissipation.

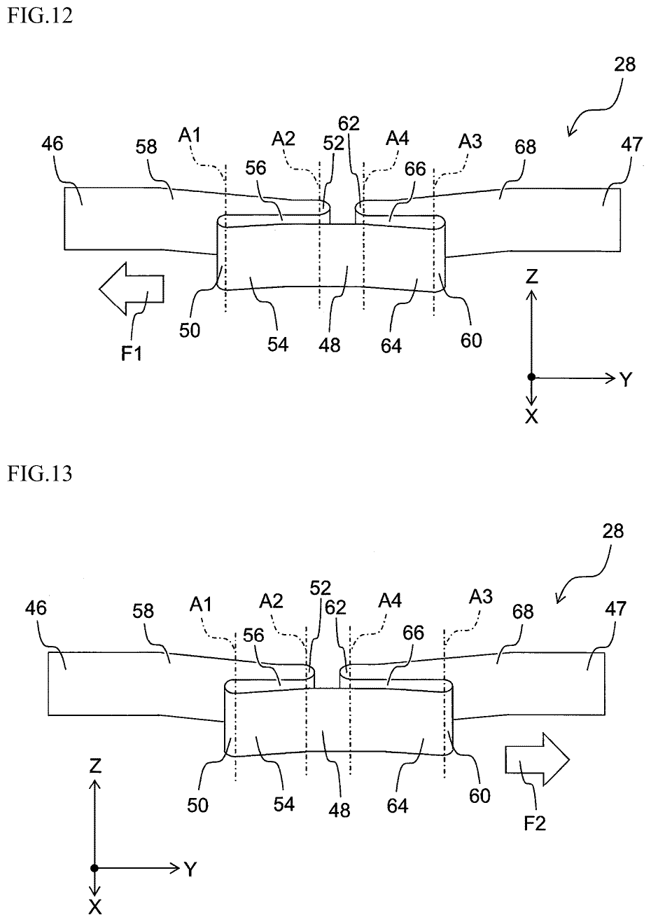

The heat transfer sheet 28 having the above configuration has bent portions 50 and 52 that are gently curved between the connection portions 46 and 48, has bent portions 60 and 62 that are gently curved between the connection portions 47 and 48, and the virtual axes A1, A2, A3, and A4 constituting the bent portions 50, 52, 60, and 62 all extend in a direction orthogonal to the optical axis L (the Z-axis direction in the first embodiment). As a result, when the connection portion 48 moves in the YZ plane with the movement of the movable portion 26, the deformation resistance of the heat transfer sheet 28 can be stably reduced. Details will be described with reference to FIGS. 12 to 17.

FIG. 12 is a schematic view illustrating a deformation state of the heat transfer sheet 28 when the connection portion 48 of the heat transfer sheet 28 moves in the left direction (arrow F1, −Y direction) of the drawing.

As illustrated in FIG. 12, when the connection portion 48 moves in the −Y direction, the extending portions 54 and 64 and the bent portions 50 and 60 adjacent to the connection portion 48 move integrally in the same direction. Since the moving direction of the connection portion 48 is a direction orthogonal to the virtual axes A1, A2, A3, and A4, portions between the connection portion 48 and the connection portions 46 and 47 including the bent portions 50, 52, 60, and 62 move in the −Y direction as a whole while maintaining the orientations of the virtual axes A1, A2, A3, and A4.

Since each of the bent portions 50, 52, 60, and 62 is a gently curved portion, the shape and position thereof are easily changed as compared with a sharply bent portion. The positions of the bent portions 50, 52, 60, and 62 can also be easily changed with less resistance according to the movement amount of the connection portion 48.

FIG. 13 is a schematic view illustrating a deformation state of the heat transfer sheet 28 when the connection portion 48 of the heat transfer sheet 28 moves in the right direction (arrow F2, +Y direction) of the drawing.

As illustrated in FIG. 13, when the connection portion 48 moves in the +Y direction, portions between the connection portion 48 and the connection portions 46 and 47 including the bent portions 50, 52, 60, and 62 move in the +Y direction as a whole while maintaining the orientations of the virtual axes A1, A2, A3, and A4. The positions of the bent portions 50, 52, 60, and 62 can also be easily changed with less resistance according to the movement amount of the connection portion 48.

As described with reference to FIGS. 12 and 13, the heat transfer sheet 28 having the bent portions 50, 52, 60, and 62 gently curved around the virtual axes A1, A2, A3, and A4 exhibits high flexibility when the connection portion 48 moves in the left direction or the right direction (arrow F1, F2) of the drawing, and can be deformed with less resistance.

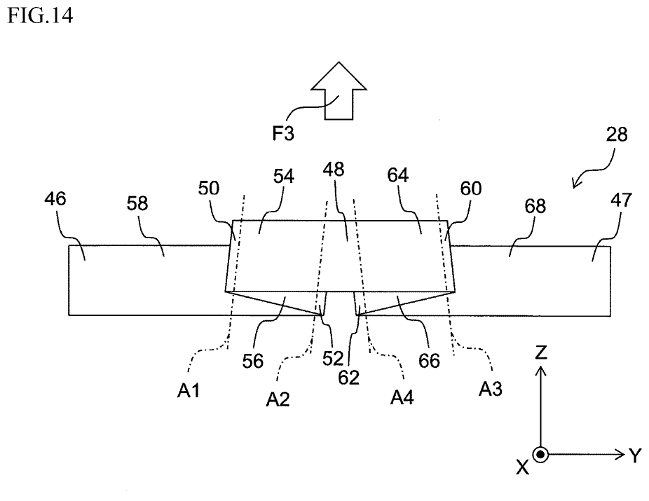

FIG. 14 is a schematic view illustrating a deformation state of the heat transfer sheet 28 when the connection portion 48 of the heat transfer sheet 28 moves in the upward direction (arrow F3, +Z direction) of the drawing.

As illustrated in FIG. 14, when the connection portion 48 moves in the +Z direction, the extending portions 54 and 64 and the bent portions 50 and 60 adjacent to the connection portion 48 move integrally in the same direction. The heat transfer sheet 28 is deformed such that the height positions of the connection portions 46 and 47 are different from the height position of the connection portion 48, and the virtual axes A1, A2, A3, and A4 move so as to be inclined with respect to the Z direction. The virtual axes A1 and A2 on the left side of the drawing are inclined such that the upper portion approaches the right side of the drawing, and the virtual axes A3 and A4 on the right side of the drawing are inclined such that the upper portion approaches the left side of the drawing.

In a region between the connection portion 46 and the connection portion 48, the bent portion 50 and the bent portion 52 are deformed. In the bent portion 50, the direction of extension on the side connected to the extending portion 54 is different from the direction of extension on the side connected to the extending portion 56, so that torsion occurs. Meanwhile, in the bent portion 52, the direction of extension on the side connected to the extending portion 56 is different from the direction of extension on the side connected to the extending portion 58, so that torsion occurs. The deformation amount and the deformation direction of the bent portion 52 change according to the deformation amount and the deformation direction of the bent portion 50, and the bent portions 50 and 52 are deformed so that resistance due to each torsion is offset. Therefore, deformation resistance can be reduced as the entire heat transfer sheet 28.

Similarly, in the region between the connection portion 47 and the connection portion 48, the two bent portions 60 and 62 are deformed so that resistance due to each torsion is offset, whereby the deformation resistance of the entire heat transfer sheet 28 can be reduced.

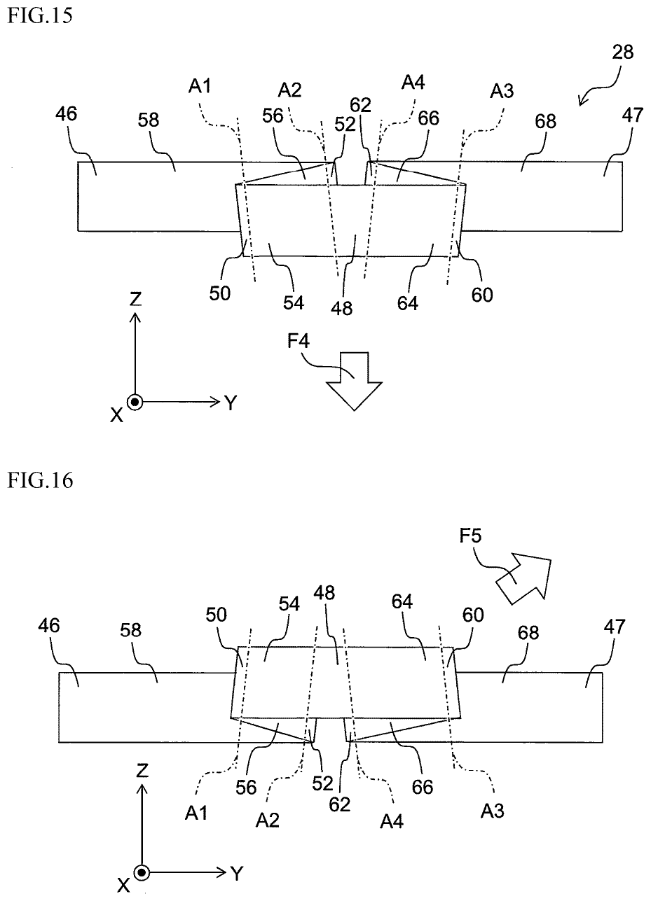

FIG. 15 is a schematic view illustrating a deformation state of the heat transfer sheet 28 when the connection portion 48 of the heat transfer sheet 28 moves in a downward direction (arrow F4, −Z direction) of the drawing.

As illustrated in FIG. 15, when the connection portion 48 moves in the −Z direction, the extending portions 54 and 64 and the bent portions 50 and 60 adjacent to the connection portion 48 integrally move in the same direction. The heat transfer sheet 28 is deformed such that the height positions of the connection portions 46 and 47 are different from the height position of the connection portion 48, and the virtual axes A1, A2, A3, and A4 move so as to be inclined with respect to the Z direction.

As in the case shown in FIG. 14, in the region between the connection portion 46 and the connection portion 48, the two bent portions 50 and 52 are deformed so as to offset the resistance due to each torsion, and in the region between the connection portion 47 and the connection portion 48, the two bent portions 60 and 62 are deformed so as to offset the resistance due to each torsion. As a result, the deformation resistance of the entire heat transfer sheet 28 can be reduced.

As described above, the heat transfer sheet 28 having the bent portions 50, 52, 60, and 62 that are gently curved around the virtual axes A1, A2, A3, and A4 exhibits high flexibility when the connection portion 48 moves in the upward direction or the downward direction (arrow F3, F4) of the drawing, and can be deformed with less resistance.

FIG. 16 is a schematic view illustrating a deformation state of the heat transfer sheet 28 when the connection portion 48 of the heat transfer sheet 28 moves obliquely upward (arrow F5) with the movement of the movable portion 26.

As illustrated in FIG. 16, when the connection portion 48 moves obliquely upward, the extending portions 54 and 64 and the bent portions 50 and 60 adjacent to the connection portion 48 move integrally in the same direction. The heat transfer sheet 28 is deformed such that the height positions of the connection portions 46 and 47 are different from the height position of the connection portion 48, and the virtual axes A1, A2, A3, and A4 move so as to be inclined with respect to the Z direction.

The movement of the connection portion 48 illustrated in FIG. 16 includes a movement component toward the upper side of the drawing and a movement component toward the right side of the drawing. The deformation of the heat transfer sheet 28 is a combination of the deformation pattern illustrated in FIG. 13 with the rightward movement of the drawing and the deformation pattern illustrated in FIG. 14 with the upward movement of the drawing.

In the region between the connection portion 46 and the connection portion 48, the two bent portions 50 and 52 are deformed so as to offset the resistance due to each torsion, and in the region between the connection portion 47 and the connection portion 48, the two bent portions 60 and 62 are deformed so as to offset the resistance due to each torsion. As a result, the deformation resistance of the entire heat transfer sheet 28 can be reduced.

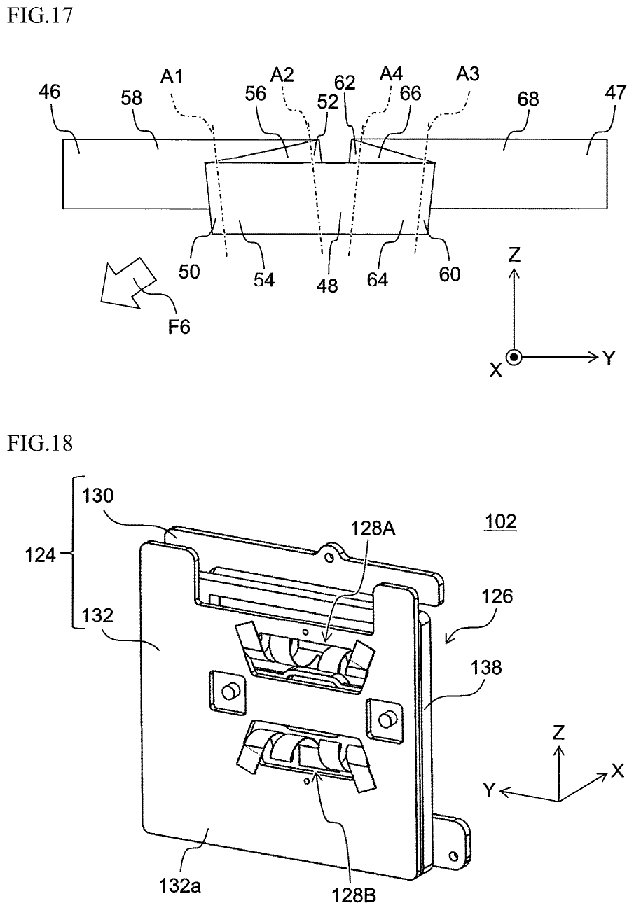

FIG. 17 is a schematic view illustrating a deformation state of the heat transfer sheet 28 when the connection portion 48 of the heat transfer sheet 28 moves obliquely downward (arrow F6) with the movement of the movable portion 26.

Since the movement of the connection portion 48 illustrated in FIG. 17 includes a movement component toward the lower side of the drawing and a movement component toward the left side of the drawing, the deformation of the heat transfer sheet 28 is a combination of the deformation pattern illustrated in FIG. 12 with the movement toward the left side of the drawing and the deformation pattern illustrated in FIG. 15 with the movement toward the lower side of the drawing.

In the region between the connection portion 46 and the connection portion 48, the two bent portions 50 and 52 are deformed so as to offset the resistance due to each torsion, and in the region between the connection portion 47 and the connection portion 48, the two bent portions 60 and 62 are deformed so as to offset the resistance due to mutual twisting, so that deformation resistance of the entire heat transfer sheet 28 can be reduced.

As described above, according to the heat transfer sheet 28 having the bent portions 50, 52, 60, and 62 curved around the virtual axes A1, A2, A3, and A4 orthogonal to the optical axis direction L, the deformation resistance can be stably reduced regardless of the moving direction and the moving amount of the connection portion 48. Consequently, power consumption for driving the movable portion 26 can be reduced, and the camera shake correction function can accurately be executed.

As described above, the imaging apparatus 2 of the first embodiment includes: the fixing portion 24 fixed inside the casing 12; the movable portion 26 that includes the imaging element 16 and moves in the direction orthogonal to the optical axis L with respect to the fixing portion 24; and the heat transfer sheet 28 (connection member) including the connection portion 46 (first connection portion) connected to the fixing portion 24 and the connection portion 48 (second connection portion) connected to the movable portion 26. The heat transfer sheet 28 includes the plurality of bent portions 50 and 52 gently curved between the connection portion 46 and the connection portion 48. The plurality of bent portions 50 and 52 include the bent portion 50 (first bent portion) curved about the first virtual axis A1 and the bent portion 52 (second bent portion) curved about the second virtual axis A2. The first virtual axis A1 and the second virtual axis A2 each extend in a direction orthogonal to the optical axis L.

According to such a configuration, by providing the plurality of gently curved bent portions 50 and 52, the deformation resistance of the heat transfer sheet 28 can be stably reduced when the movable portion 26 moves in the direction orthogonal to the optical axis L.

In the imaging apparatus 2 of the first embodiment, the first virtual axis A1 and the second virtual axis A2 are parallel to each other. Accordingly, the shape of the heat transfer sheet 28 can be simplified.

Furthermore, in the imaging apparatus 2 of the first embodiment, the connection portion 46 (first connection portion) and the connection portion 48 (second connection portion) are at positions shifted along the direction orthogonal to the optical axis L. As a result, even when the connection portion 46 and the connection portion 48 are at positions separated from each other, the connection can be performed by easily arranging the direction in which the heat transfer sheet 28 extends by having the two bent portions 50 and 52.

In the imaging apparatus 2 of the first embodiment, the heat transfer sheet 28 (connection member) includes the extending portion 56 extending between the bent portion 50 (first bent portion) and the bent portion 52 (second bent portion), and the reinforcing plate 70 attached to the extending portion 56. As a result, portions other than the extending portions 56 (for example, the bent portions 50 and 52) can be easily bent, and the deformation operation of the heat transfer sheet 28 can be stabilized.

Furthermore, in the imaging apparatus 2 of the first embodiment, the heat transfer sheet 28 (connection member) extends in the first direction (arrow Y1) from the connection portion 48 (second connection portion) toward the bent portion 50 (first bent portion), extends in the second direction (arrow Y2) opposite to the first direction from the bent portion 50 toward the bent portion 52 (second bent portion), and extends in the first direction from the bent portion 52 toward the connection portion 46 (first connection portion). As a result, by curving the heat transfer sheet 28 in an S shape, it is possible to easily perform connection even when the connection portion 48 and the connection portion 46 are at positions separated from each other, and connection work can also be easily performed.

Furthermore, in the imaging apparatus 2 of the first embodiment, the connection member that connects the fixing portion 24 and the movable portion 26 is the heat transfer sheet 28 that transfers the heat of the movable portion 26 to the fixing portion 24. As a result, the heat of the movable portion 26 can be dissipated using the heat transfer sheet 28.

Furthermore, in the imaging apparatus 2 of the first embodiment, the heat transfer sheet 28 (connection member) includes the connection portion 47 (third connection portion) connected to the fixing portion 24 at a position different from the connection portion 46 (first connection portion), and the plurality of bent portions 60 and 62 gently curved between the connection portion 48 (second connection portion) and the connection portion 47. The plurality of bent portions 60 and 62 include the bent portion 60 (third bent portion) curved around the third virtual axis A3 and the bent portion 62 (fourth bent portion) curved around the fourth virtual axis A4. The third virtual axis A3 and the fourth virtual axis A4 each extend in the direction orthogonal to the optical axis L. As a result, the heat transfer sheet 28 can be connected to the fixing portion 24 in a well-balanced manner, and the heat dissipation of the heat transfer sheet 28 can be improved.

Furthermore, in the imaging apparatus 2 of the first embodiment, the heat transfer sheet 28 (connection member) extends in the first direction (arrow Y1) from the connection portion 48 (second connection portion) toward the bent portion 50 (first bent portion), and extends in the second direction (arrow Y2) from the connection portion 48 toward the bent portion 60 (third bent portion). As a result, the heat transfer sheet 28 can be connected to the fixing portion 24 in a well-balanced manner.

In the imaging apparatus 2 of the first embodiment, the first direction (arrow Y1) and the second direction (arrow Y2) are opposite to each other. As a result, the heat transfer sheet 28 can be connected to the fixing portion 24 in a well-balanced manner.

Furthermore, in the imaging apparatus 2 of the first embodiment, the bent portion 50 (first bent portion) is curved from the first direction (arrow Y1) to the second direction (arrow Y2) toward the bent portion 52 (second bent portion), the bent portion 52 is curved from the second direction to the first direction, the bent portion 60 (third bent portion) is curved from the second direction to the first direction toward the bent portion 62 (fourth bent portion), and the bent portion 62 is curved from the first direction to the second direction. As a result, by curving the heat transfer sheet 28 in an S shape, it is possible to easily perform connection even when the connection portion 48 and the connection portions 46 and 47 are at positions separated from each other, and connection work can also be easily performed.

### Second Embodiment

A peripheral structure of a camera shake correction mechanism according to the second embodiment of the present invention will be described with reference to FIGS. 18 to 20. In the second embodiment, points different from the first embodiment will be mainly described. In addition, the same or equivalent configurations are denoted by the same reference numerals, and the description thereof will be omitted.

While the heat transfer sheet 28 has an S-shape in plan view in the first embodiment, the second embodiment is different from the first embodiment in that the heat transfer sheet has a spiral shape.

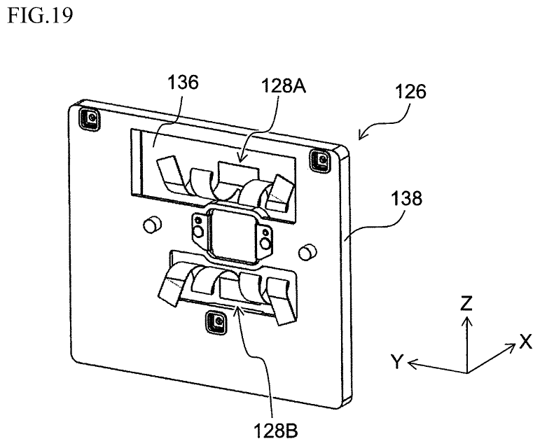

FIG. 18 is a perspective view illustrating a peripheral structure of a camera shake correction mechanism according to the second embodiment, and FIG. 19 is a perspective view of a state in which a fixing portion is omitted from the structure illustrated in FIG. 18.

As illustrated in FIG. 18, an imaging apparatus of the second embodiment includes a fixing portion 124, a movable portion 126, and heat transfer sheets 128A and 128B.

The fixing portion 124 has two fixing frames 130 and 132. The movable portion 126 includes the imaging element 16 (FIG. 3) movable in the YZ plane, a sensor substrate 136 (FIG. 19), and a movable frame 138. The heat transfer sheets 128A and 128B are connection members connected between the fixing portion 124 and the movable portion 126, and are attached to the fixing frame 132 and the sensor substrate 136, respectively, in the second embodiment.

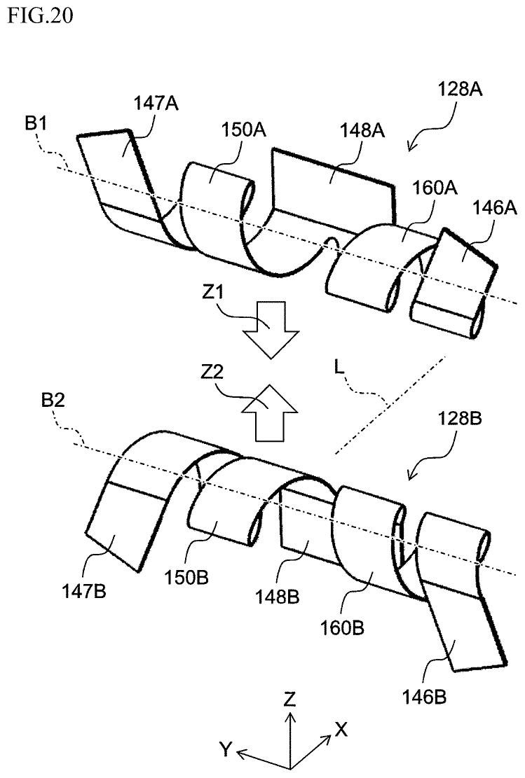

FIG. 20 is a perspective view illustrating each of the heat transfer sheets 128A and 128B.

As illustrated in FIG. 20, the heat transfer sheet 128A includes three connection portions 146A, 147A, and 148A and two bent portions 150A and 160A.

Each of the connection portions 146A and 147A is attached to the fixing frame 132 via an adhesive member such as a double-sided tape, and the connection portion 148A is attached to the sensor substrate 136 via an adhesive member such as a double-sided tape.

The bent portions 150A and 160A are portions that are spirally curved between the connection portions 146A and 147A and the connection portion 148A, respectively. The bent portion 150A is spirally curved about a central axis B1 between the connection portion 147A and the connection portion 148A, and the bent portion 160A is spirally curved about the central axis B1 between the connection portion 146A and the connection portion 148A. In the second embodiment, the central axes B1 of the two bent portions 150A and 160A coincide with each other.

The bent portions 150A and 160A are bifurcated and extended from the connection portion 148A. The bent portions 150A and 160A of the second embodiment extend in the −Z direction (arrow Z1) from different positions in the left-right direction at the lower end portion of the connection portion 148A.

Similarly, the heat transfer sheet 128B has three connection portions 146B, 147B, and 148B and two bent portions 150B and 160B.

The bent portion 150B is spirally curved about the central axis B2 between the connection portion 147B and the connection portion 148B, and the bent portion 160B is spirally curved about the central axis B2 between the connection portion 146B and the connection portion 148B.

The bent portions 150B and 160B are bifurcated and extended from the connection portion 148B and extend in the +Z direction (arrow Z2) from different positions in the left-right direction at the upper end portion of the connection portion 148B.

The two heat transfer sheets 128A and 128B illustrated in FIG. 20 have vertically symmetrical shapes. Hereinafter, the heat transfer sheets 128A and 128B are collectively referred to as a “heat transfer sheet 128”, and the same notation may be used for each component.

Both the bent portions 150 and 160 of the heat transfer sheet 128 are curved portions that are gently curved around the virtual axes B1 and B2 orthogonal to the optical axis direction L, and are spirally curved. When the connection portion 148 moves in the YZ plane with the movement of the movable portion 126, the bent portions 150 and 160 are three-dimensionally deformed according to the moving direction and the moving amount of the connection portion 148. Even when the connection portion 148 moves in any direction, the bent portions 150 and 160 are deformed so as to absorb deformation resistance due to torsion as a whole, so that deformation resistance of the entire heat transfer sheet 128 can be reduced.

In the second embodiment, the virtual axes B1 and B2 both extend in the left-right direction (Y-axis direction), and the heat transfer sheet 128 is formed to be long in the left-right direction. In the configuration in which the casing 12 has a laterally long shape, the internal space of the casing 12 can be effectively used.

As described above, the imaging apparatus 102 of the second embodiment includes the fixing portion 124 fixed inside the casing 12, the movable portion 126 that includes the imaging element 16 and moves in the direction orthogonal to the optical axis L with respect to the fixing portion 124, and the heat transfer sheet 128 (connection member) including the connection portion 146 (first connection portion) connected to the fixing portion 124 and the connection portion 148 (second connection portion) connected to the movable portion 126. The heat transfer sheet 128 includes the bent portion 150 (first bent portion) gently curved between the connection portion 146 and the connection portion 148, and the bent portion 150 is spirally curved.

According to such a configuration, by providing the spirally curved bent portion 150, the deformation resistance of the heat transfer sheet 128 can be stably reduced when the movable portion 126 moves in the direction orthogonal to the optical axis L.

Furthermore, in the imaging apparatus 102 of the second embodiment, the bent portion 150 (first bent portion) is spirally curved around the first virtual axis B1 extending in the direction orthogonal to the optical axis L. According to such a configuration, for example, the heat transfer sheet 128 is formed long in the left-right direction, and the internal space of the casing 12 can be effectively utilized.

Furthermore, in the imaging apparatus 102 of the second embodiment, the heat transfer sheet 128 (connection member) includes the connection portion 147 (third connection portion) connected to the fixing portion 124 at a position different from the connection portion 146 (first connection portion), and the bent portion 160 (second bent portion) gently curved between the connection portion 148 (second connection portion) and the connection portion 147, and the bent portion 160 is spirally curved. According to such a configuration, the heat transfer sheet 128 can be connected to the fixing portion 124 in a well-balanced manner, and the heat dissipation of the heat transfer sheet 128 can be improved.

Furthermore, in the imaging apparatus 102 of the second embodiment, the heat transfer sheet 128 (connection member) extends from the connection portion 148 (second connection portion) toward the bent portion 150 (first bent portion) and extends from the connection portion 148 toward the bent portion 160 (second bent portion), thereby having a bifurcated shape. According to such a configuration, the heat transfer sheet 128 can be connected to the fixing portion 124 in a well-balanced manner, and the heat dissipation of the heat transfer sheet 128 can be improved.

Although the present invention has been described above with reference to the first and second embodiments, the present invention is not limited to the first and second embodiments. For example, in the first and second embodiments, the heat transfer sheets 28 and 128 are exemplified as the connection members connecting the fixing portions 24 and 124 and the movable portions 26 and 126, but the present invention is not limited to such a case, and a member (for example, a flexible cable) different from the heat transfer sheet may be used.

In addition, in the first and second embodiments, the case where the heat transfer sheets 28 and 128 are each bifurcated on one side and the other side from the connection portions 48 and 148 has been described. However, the present invention is not limited to such a case, and the heat transfer sheets 28 and 128 may each extend only to one of one side and the other side. In this case, the number of gently curved bent portions is not limited to two, and three or more bent portions may be provided.

In the first embodiment, the case where the virtual axes A1, A2, A3, and A4 extend in the Z-axis direction has been described. However, the present invention is not limited to such a case, and the virtual axes A1, A2, A3, and A4 may extend in any direction as long as the directions are orthogonal to the optical axis L (for example, in a case of extending in the Y-axis direction or in a case of extending obliquely in the YZ plane,). In the second embodiment, the case where the virtual axes B1 and B2 extend in the Y-axis direction has been described, but the present invention is not limited to such a case, and the virtual axes B1 and B2 may extend in any direction as long as the direction is orthogonal to the optical axis L (for example, in a case of extending in the Z-axis direction or in a case of extending obliquely in the YZ plane).

Although the present disclosure has been fully described in connection with preferred embodiments with reference to the accompanying drawings, various modifications and corrections will be apparent to those skilled in the art. Such modifications and corrections are to be understood as being included within the scope of the present invention as set forth in the appended claims as long as they do not depart therefrom. In addition, combinations of elements and changes in order in each embodiment can be realized without departing from the scope and spirit of the present disclosure.

By appropriately combining any embodiments or modifications among the embodiments or the various modifications, the effects of the respective embodiments or modifications can be achieved.

The present disclosure is applicable to an imaging apparatus that captures an image of a subject such as a digital camera.

What is claimed is:

1. An imaging apparatus comprising:
a fixing portion fixed inside a casing;
a movable portion that includes an imaging element and moves in a direction orthogonal to an optical axis with respect to the fixing portion; and
a connection member including a first connection portion connected to the fixing portion and a second connection portion connected to the movable portion,
wherein the connection member includes a plurality of bent portions gently curved between the first connection portion and the second connection portion,
wherein the plurality of bent portions include a first bent portion curved about a first virtual axis and a second bent portion curved about a second virtual axis, and
wherein the first virtual axis and the second virtual axis each extend in a direction orthogonal to the optical axis.

2. The imaging apparatus according to claim 1, wherein the first virtual axis and the second virtual axis are parallel to each other.

3. The imaging apparatus according to claim 1, wherein the first connection portion and the second connection portion are at positions shifted from each other along a direction orthogonal to the optical axis.

4. The imaging apparatus according to claim 1, wherein the connection member includes an extending portion extending between the first bent portion and the second bent portion, and a reinforcing plate attached to the extending portion.

5. The imaging apparatus according to claim 1, wherein the connection member extends in a first direction from the second connection portion toward the first bent portion, extends in a second direction opposite to the first direction from the first bent portion toward the second bent portion, and extends in the first direction from the second bent portion toward the first connection portion.

6. The imaging apparatus according to claim 1, wherein the connection member is a heat transfer sheet that transfers heat of the movable portion to the fixing portion.

7. The imaging apparatus according to claim 1,
wherein the connection member includes a third connection portion connected to the fixing portion at a position different from the first connection portion, and a plurality of bent portions gently curved between the second connection portion and the third connection portion,
wherein the plurality of bent portions include a third bent portion curved about a third virtual axis and a fourth bent portion curved about a fourth virtual axis, and
wherein each of the third virtual axis and the fourth virtual axis extends in a direction orthogonal to the optical axis.

8. The imaging apparatus according to claim 7, wherein the connection member extends in a first direction from the second connection portion toward the first bent portion, and extends in a second direction from the second connection portion toward the third bent portion.

9. The imaging apparatus according to claim 8, wherein the first direction and the second direction are opposite to each other.

10. The imaging apparatus according to claim 8,
wherein the first bent portion is curved from the first direction to the second direction toward the second bent portion, and the second bent portion is curved from the second direction to the first direction, and
wherein the third bent portion is curved from the second direction to the first direction toward the fourth bent portion, and the fourth bent portion is curved from the first direction to the second direction.

11. An imaging apparatus comprising:
a fixing portion fixed inside a casing;
a movable portion that includes an imaging element and moves in a direction orthogonal to an optical axis with respect to the fixing portion; and
a connection member including a first connection portion connected to the fixing portion and a second connection portion connected to the movable portion,
wherein the connection member includes a first bent portion gently curved between the first connection portion and the second connection portion, and
wherein the first bent portion is spirally curved.

12. The imaging apparatus according to claim 11, wherein the first bent portion is spirally curved about a first virtual axis extending in a direction orthogonal to the optical axis.

13. The imaging apparatus according to claim 11,
wherein the connection member includes a third connection portion connected to the fixing portion at a position different from the first connection portion, and a second bent portion gently curved between the second connection portion and the third connection portion, and
wherein the second bent portion is spirally curved.

14. The imaging apparatus according to claim 13, wherein the connection member has a bifurcated shape extending from the second connection portion toward the first bent portion and extending from the second connection portion toward the second bent portion.
